(19) United States
(12) Patent Application Publication
(10) Pub. No.: US 2026/0044131 A1
(43) Pub. Date: Feb. 12, 2026

(54) PRODUCTION LINE ANALYSIS SYSTEM, PRODUCTION LINE ANALYSIS METHOD, AND NON-TRANSITORY COMPUTER-READABLE RECORDING MEDIUM

(71) Applicant: TOYOTA JIDOSHA KABUSHIKI KAISHA, Aichi-ken (JP)

(72) Inventor: Kento MURAKATA, Nagoya-shi (JP)

(21) Appl. No.: 19/281,760

(22) Filed: Jul. 28, 2025

(30) Foreign Application Priority Data
Aug. 9, 2024 (JP) 2024-134024

(51) Int. Cl. G05B 19/401; G05B 19/4069

(52) U.S. Cl. CPC G05B 19/401; G05B 19/4069

(57) ABSTRACT

A production line analysis system includes one or more processors, a display device, and a user interface. The one or more processors are configured to: display, on the display device, a first window showing a lead time distribution of a plurality of workpieces that have passed through first equipment included in one or more pieces of equipment, based on a result of a simulation of a production line including the one or more pieces of equipment; receive, through the user interface, a first operator input to select one of the plurality of workpieces displayed in the first window; and, in response to the first operator input, display, on the display device, detailed information regarding the first equipment at a time when a selected workpiece, which is a workpiece selected by the first operator input, passes through the first equipment.

### CROSS-REFERENCES TO RELATED APPLICATION

The present disclosure claims priority under 35 U.S.C. § 119 to Japanese Patent Application No. 2024-134024, filed on Aug. 9, 2024, which is incorporated herein by reference in its entirety.

### BACKGROUND

### Technical Field

The present disclosure relates to a technique for analysis of a production line.

### Background Art

JP 2002-244716 A discloses a line capacity evaluation system that identifies a bottleneck in a production line through simulation. The line capacity evaluation system simulates the behavior of workpieces flowing through the production line and identifies, as a bottleneck, a piece of equipment that is not achieving the targets for average production volume and average lead time.

JP 2007-140625 A discloses a production management device that manages the progress of production on a production line consisting of a plurality of processes. The production management device acquires work performance data (e.g., information on work time) that includes multiple pieces of performance information (information for each process) related to the work progress of a non-target object, and counts, as an abnormal number for each process, the number of pieces of performance information included in the work performance data that do not satisfy a predetermined condition.

JP 2022-150813 A discloses a design support device that supports design work by presenting the knowledge of experts. The design support device searches for a portion on a task execution screen that matches knowledge data stored in an expert knowledge database, and prompts a user to look at any of the searched portions that the user has not yet looked at. JP 2012-146202 A discloses a workflow management device that changes a workflow based on the results of analyzing behavioral information acquired from a worker in order to reflect tacit knowledge of an expert in the workflow. However, the techniques described in JP 2022-150813 A and JP 2012-146202 A do not relate to analysis of simulation results.

### SUMMARY

The technique described in JP 2002-244716 A merely identifies a bottleneck in the production line based on the average production volume and the average lead time but is unable to identify the cause of anomaly occurring for an individual workpiece. Similarly, the technique described in JP 2007-140625 A cannot identify the cause of the occurrence of abnormality in an individual workpiece.

A production line analysis system according to the present disclosure includes one or more processors, a display device, and a user interface. The one or more processors are configured to: display, on the display device, a first window showing a lead time distribution of a plurality of workpieces that have passed through first equipment included in one or more pieces of equipment, based on a result of a simulation of a production line including the one or more pieces of equipment; receive, through the user interface, a first operator input to select one of the plurality of workpieces displayed in the first window; and, in response to the first operator input, display, on the display device, detailed information regarding the first equipment at a time when a selected workpiece, which is a workpiece selected by the first operator input, passes through the first equipment.

A production line analysis method according to the present disclosure, which is executed by a computer, includes: displaying, on a display device, a first window showing a lead time distribution of a plurality of workpieces that have passed through first equipment included in one or more pieces of equipment, based on a result of a simulation of a production line including the one or more pieces of equipment; receiving, through a user interface, a first operator input to select one of the plurality of workpieces displayed in the first window; and, in response to the first operator input, displaying, on the display device, detailed information regarding the first equipment at a time when a selected workpiece, which is a workpiece selected by the first operator input, passes through the first equipment.

A non-transitory computer-readable recording medium according to the present disclosure stores a production line analysis program executed by a computer. The production line analysis program causes the computer to execute: displaying, on a display device, a first window showing a lead time distribution of a plurality of workpieces that have passed through first equipment included in one or more pieces of equipment, based on a result of a simulation of a production line including the one or more pieces of equipment; receiving, through a user interface, a first operator input to select one of the plurality of workpieces displayed in the first window; and, in response to the first operator input, displaying, on the display device, detailed information regarding the first equipment at a time when a selected workpiece, which is a workpiece selected by the first operator input, passes through the first equipment.

According to the present disclosure, the first window showing a lead time distribution of a plurality of workpieces that have passed through the first equipment is displayed based on the result of a simulation of a production line including one or more pieces of equipment. The first operator input to select one of the plurality of workpieces displayed in the first window is received. Then, in response to the first operator input, detailed information regarding the first equipment at a time when the selected workpiece passes through the first equipment is displayed. This makes it easier to identify the cause of anomaly that may occur in relation to the selected workpiece.

### BRIEF DESCRIPTION OF THE DRAWINGS

FIG. 1 is a block diagram showing an example of a configuration of a production line analysis system according to a first embodiment;

FIG. 2 is a flowchart illustrating an example of a flow of processing executed by the analysis system according to the first embodiment to provide information to an operator;

FIG. 3 is a diagram showing an example of a screen of a display device including a display of a window WN1;

FIG. 4 is a diagram showing an example of detailed information DI displayed on the display device;

FIG. 5 is a diagram showing another example of the detailed information DI displayed on the display device;

FIG. 6 is a flowchart showing an example of a flow of processing executed by a production line analysis system according to a modified example of the first embodiment;

FIG. 7 is a diagram showing an example of a screen of the display device including a display of a window WN2 together with the window WN1;

FIG. 8 is a block diagram showing an example of a configuration of a production line analysis system according to a second embodiment;

FIG. 9 is a flowchart showing an example of a flow of processing executed by the analysis system according to the second embodiment to provide information to the operator;

FIG. 10 is a diagram showing an example of a screen of the display device including a display of the window WN1 accompanied by presentation of a recommended workpieces Wp;

FIG. 11 is a diagram showing an example of a screen of the display device including a display of recommendation information Ip1;

FIG. 12 is a block diagram showing an example of a configuration of a production line analysis system according to a third embodiment;

FIG. 13 is a flowchart showing an example of a flow of processing executed by the analysis system according to the third embodiment to provide information to the operator;

FIG. 14 is a diagram showing an example of a screen of the display device including a display of the window WN2 accompanied by presentation of a recommended viewpoint Vp; and

FIG. 15 is a diagram showing an example of a screen of the display device including a display of recommendation information Ip2.

### DETAILED DESCRIPTION

Embodiments of the present disclosure will be described with reference to the accompanying drawings.

### 1. First Embodiment

### 1-1. Overview of Production Line Analysis System

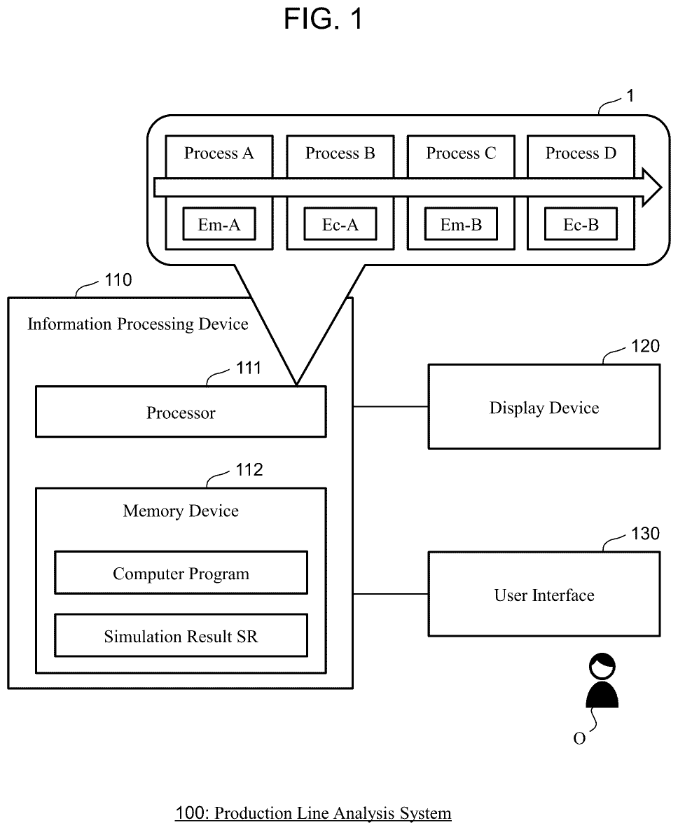

FIG. 1 is a block diagram showing an example of a configuration of a production line analysis system 100 according to the first embodiment. The production line analysis system (hereinafter, simply referred to as an analysis system) 100 is a system that provides an operator O with a result SR of a simulation of a production line including one or more pieces of equipment E. The analysis system 100 includes an information processing device 110, a display device 120, and a user interface 130.

A production line 1 shown in FIG. 1 is a battery production line, which is an example of a production line to be simulated. The production line 1 includes a plurality of processes. The individual processes are carried out using one or more pieces of equipment E. The equipment E referred to here includes, for example, manufacturing equipment Em and conveying equipment Ec. The manufacturing equipment Em is various kinds of equipment (e.g., processing equipment such as a press, coating and drying equipment, coating equipment, laminating equipment) used in manufacturing a workpiece (production object) W. The conveying equipment Ec is equipment (e.g., conveyor equipment) used to convey the workpiece W. In the example shown in FIG. 1, the production line 1 includes a process A using a manufacturing equipment Em-A, a process B using a conveying equipment Ec-A, a process C using a manufacturing equipment Em-B, and a process D using a conveying equipment Ec-B.

The simulation of the production line 1 can be performed, for example, using digital twin technology. A simulation program is a computer program for performing the simulation. The information processing device 110 itself of the analysis system 100 may perform the simulation to acquire a simulation result SR. Alternatively, the information processing device 110 may acquire a simulation result SR from a system external to the analysis system 100.

More specifically, the information processing device 110 includes one or more processors 111 (hereinafter, simply referred to as a processor 111) and one or more memory devices 112 (hereinafter, simply referred to as a memory device 112). The processor 111 executes various processes related to providing the simulation result SR to the operator O. Examples of the processor 111 include a general-purpose processor, a specific application processor, a central processing unit (CPU), a graphics processing unit (GPU), an application specific integrated circuit (ASIC), and a field-programmable gate array (FPGA). The processor 111 may also be referred to as processing circuitry. The memory device 112 stores various kinds of information. The various kinds of information includes the simulation result SR. Examples of the memory device 112 include a volatile memory, a non-volatile memory, a hard disk drive (HDD), and a solid state drive (SSD).

The functions of the information processing device 110 may be realized by cooperation between the processor 111 that executes a computer program and the memory device 112. The computer program is stored in the memory device 112. Alternatively, the analysis program may be recorded in a non-transitory computer-readable recording medium. In addition, in an example in which the information processing device 110 executes the simulation described above, the processor 111 executes a simulation program. That is, in this example, the computer program includes the simulation program.

The display device 120 is used to present the simulation result SR to the operator O. Specifically, the display device 120 displays the simulation result SR in accordance with an instruction from the information processing device 110. The display device 120 may be a display or a touch panel, for example.

The user interface 130 is operated by the operator O who analyzes the simulation result SR while looking at the display device 120. The analysis of the simulation result SR by the operator O is performed, for example, when the production line 1 is designed or when the production line 1 is improved. Examples of the user interface 130 include a touch panel, a keyboard, and a mouse. In the example of the touch panel, the user interface 130 and the display device 120 may be integrally configured.

According to the analysis system 100 described above, the operator O is provided with a tool for analyzing the simulation result SR.

### 1-2. Providing Information on Simulation Result

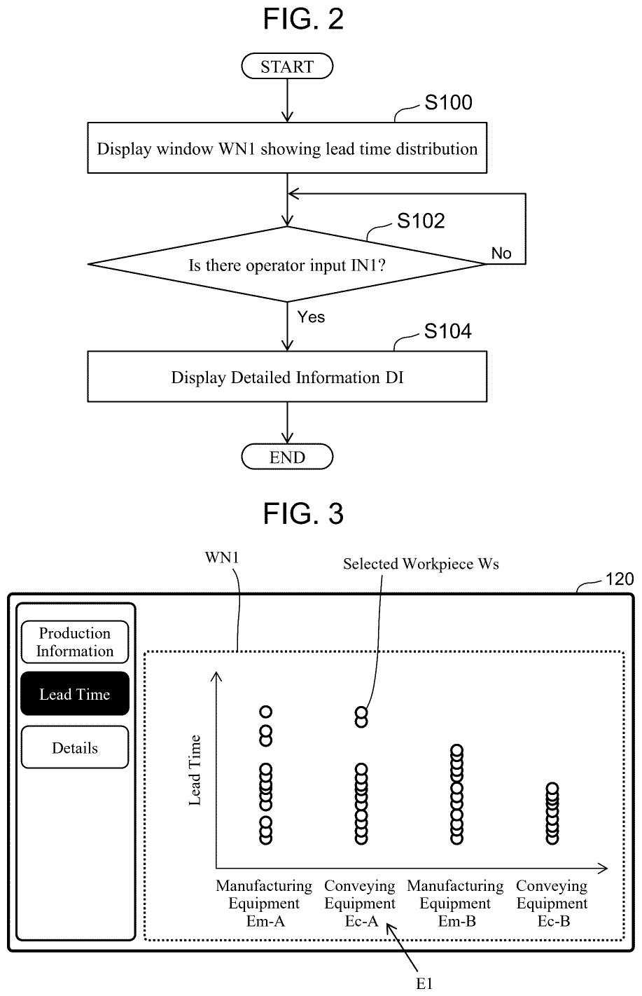

FIG. 2 is a flowchart illustrating an example of the flow of processing executed by the analysis system 100 according to the first embodiment to provide information to the operator O. The processing of this flowchart is started, for example, in response to a request from the operator O who operates the user interface 130.

In step S100, the information processing device 110 (processor 111) displays, on the display device 120, a window WN1 (first window) showing a lead time distribution, based on the simulation result SR of the production line 1. In other words, the information processing device 110 displays the window WN1 showing the lead time distribution from an obtained simulation result SR. The lead time distribution is the distribution of lead times of a plurality of workpieces W that have passed through one or more pieces of equipment E (including at least “equipment E1 (first equipment)” described below) among multiple pieces of equipment E included in the production line 1. In addition, the lead time is the time from the start to the end of a process for a workpiece W using a piece of equipment E. Furthermore, the passage of a workpiece W through a piece of equipment E corresponds to the end of a process using the piece of equipment E.

FIG. 3 is a diagram showing an example of a screen of the display device 120 including a display of the window WN1. In the example shown in FIG. 3, the window WN1 shows a lead time distribution of a designated number of workpieces W (circles in FIG. 3) that have passed through each of a designated number of pieces of equipment E. An example of the designated number of pieces of equipment E is the manufacturing equipment Em-A, the conveying equipment Ec-A, the manufacturing equipment Em-B, and the conveying equipment Ec-B. The designated number of pieces of equipment E displayed in the window WN1 may be one or may be two, three, five, or more. The equipment E displayed may be all the equipment E included in the production line 1.

Moreover, one or more pieces of equipment E and one or more workpieces W displayed in the window WN1 may be extracted based on the following designated condition. The designated condition mentioned here is, for example, that the lead time is longer than or equal to a designated threshold value (e.g., an average lead time of the same equipment, a designated reference value), in other words, that the lead time is within an outlier range. In statistics, an outlier is a value that deviates significantly from other values.

Moreover, an operation record of the operator O who viewed the window WN1 may be used to extract the one or more pieces of equipment E and one or more workpieces W displayed in the window WN1. More specifically, the information processing device 110 may accumulate a record of the workpiece W that the operator O (particularly, an expert) has confirmed by operating the user interface 130, and may learn the tendency of the operator O to confirm the workpiece W based on the record, for example by using machine learning. Then, the information processing device 110 may extract one or more pieces of equipment E and one or more workpieces W in accordance with the learned tendency.

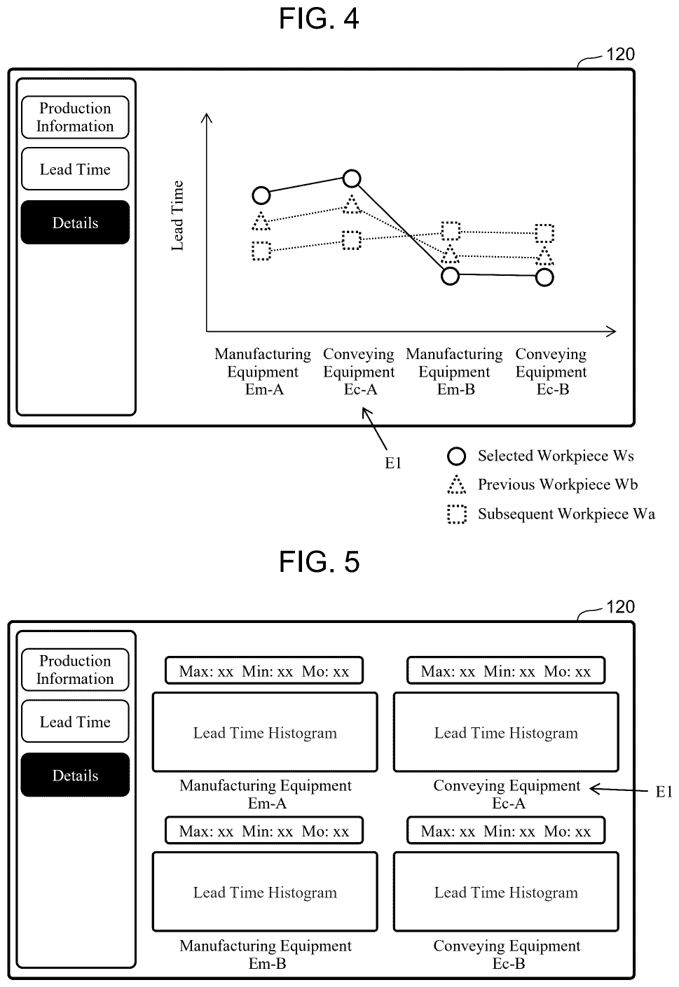

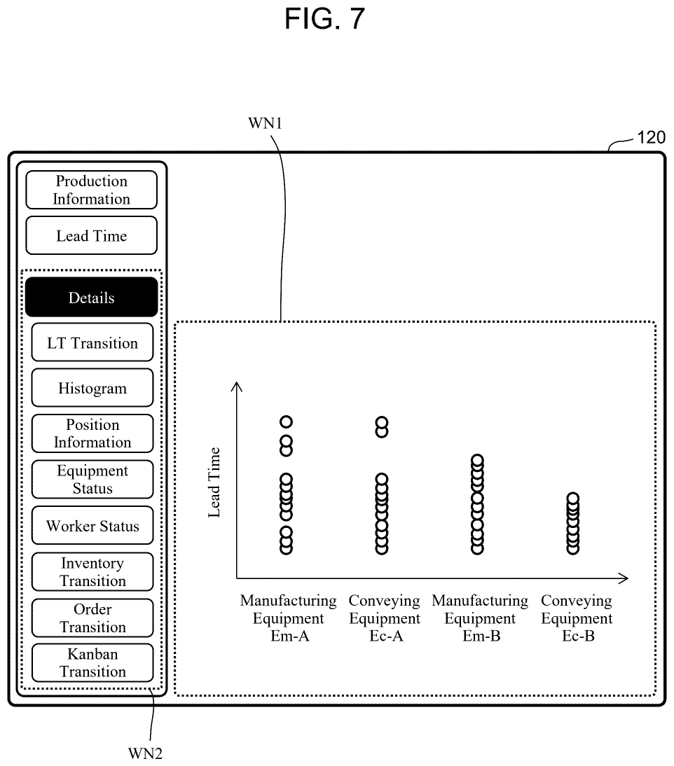

Additionally, the simulation result SR may include, for example, production information along with the lead time distribution. As shown in FIG. 3, the screen of the display device 120 may include, for example, displays of a button of “Lead Time” button and a button of “Production Information” button. The colors of the text and background of the button of “Lead Time” are inverted as shown in FIG. 3 when the lead time distribution is displayed. When the operator O operates the user interface 130 to press the button of “Production Information”, the display of the window WN1 may be switched to display the production information. The production information is, for example, production information for each process (e.g., production number of workpiece W, process availability rate, process operating rate, inventory information, standby time), and production information for all processes (e.g., production number, availability rate, operating rate). The production information may be displayed with a graphical representation, such as a line graph or a bar graph. Further, as shown in FIG. 3, the screen of the display device 120 may include a text display of “Details” in which the colors of the text and background are inverted when detailed information DI is displayed (For example, see FIG. 4). In the example shown in FIG. 7, which will be described below, the text display of “Details” functions as a button.

After step S100, the processing proceeds to step S102. After the window WN1 is displayed by the processing of step S100, the information processing device 110 receives an operator input IN1 (first operator input) through the user interface 130. The operator input IN1 is an input by the operator O to select one of a plurality of workpieces W displayed in the window WN1. More specifically, in the example in which a plurality of pieces of equipment E are displayed in the window WN1 as shown in FIG. 3, the operator O operates the user interface 130 to select a workpiece W with the selection of a piece of equipment E. The piece of equipment E selected by the operator O in this manner corresponds to “equipment E1 (first equipment)”. In the example shown in FIG. 3, the conveying equipment Ec-A corresponds to the equipment E1. Furthermore, in the following description, the workpiece W selected by the operator O will be referred to as a “selected workpiece Ws”.

In step S102, the information processing device 110 determines whether or not the operator input IN1 has been received. As a result, when the operator input IN1 is detected (step S102; Yes), the processing proceeds to step S104. In addition, for example, when there is no operator input IN1 within a designated period of time after the window WN1 is displayed, the information processing device 110 may end the processing shown in FIG. 2.

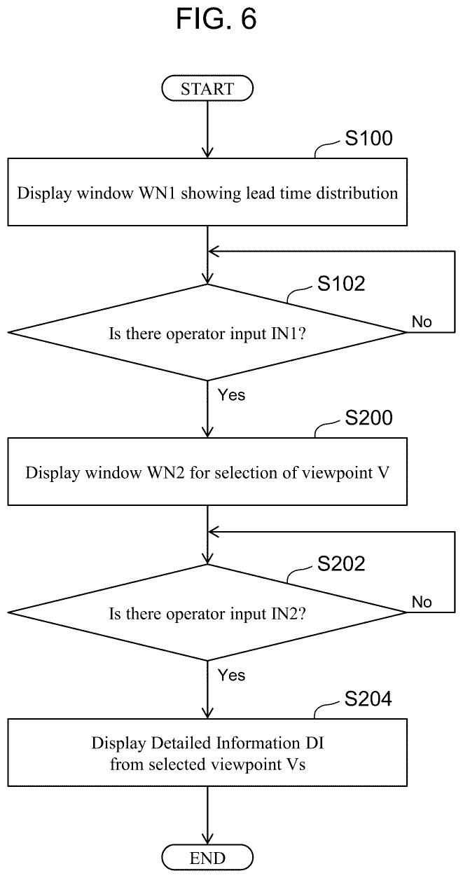

In step S104, in response to the operator input IN1, the information processing device 110 displays, on the display device 120, the detailed information DI regarding the equipment E1 at a time when the selected workpiece Ws passes through the equipment E1. More specifically, the information processing device 110 may automatically display, on the display device 120, one of the specific examples of the detailed information DI shown below, for example. Alternatively, for example, as in a modified example described below with reference to FIGS. 6 and 7, the information processing device 110 may display, on the display device 120, the detailed information DI desired by the operator O.

To be more specific, the detailed information DI may include not only information regarding the equipment E1 for the selected workpiece Ws, but also the following detailed information. In other words, the detailed information DI may include detailed information regarding the equipment E1 for at least one of a workpiece Wb passing through the equipment E1 immediately before the selected workpiece Ws, and a workpiece Wa passing through the equipment E1 immediately after the selected workpiece Ws. The number of each of the workpieces Wb and Wa may be one or more. Furthermore, the detailed information DI may include detailed information regarding at least one of equipment Eb through which the selected workpiece Ws passes immediately before the equipment E1 and equipment Ea through which the selected workpiece Ws passes immediately after the equipment E1. Each of the number of pieces of equipment Eb and the number of pieces of equipment Ea may be one or more.

### (Specific Examples of Detailed Information DI)

The detailed information DI has various viewpoints V. Specifically, the viewpoint V of the detailed information DI includes, for example, at least one of lead time transition (LT transition), lead time histogram, position information, equipment status, worker status, inventory transition, order transition, and kanban transition. Specific examples of the detailed information DI from the viewpoint V exemplified here will be described as follows.

First, FIG. 4 is a diagram showing an example of the detailed information DI displayed on the display device 120. FIG. 4 shows a specific example of the detailed information DI from the viewpoint V of the lead time transition. In FIG. 4, the transition of the lead time at a time when the same workpiece W (selected workpiece Ws; circles) passes through a plurality of (e.g., four) consecutive pieces of equipment E (i.e., processes) is shown by a scatter diagram. More specifically, the detailed information DI in this example includes not only the lead time at a time when the selected workpiece Ws passes through the conveying equipment Ec-A corresponding to the equipment E1, but also the lead time at a time when the selected workpiece Ws passes through the manufacturing equipment Em-A (corresponding to the equipment Eb) immediately before the conveying equipment Ec-A. Similarly, the detailed information DI includes the lead time at a time when the selected workpiece Ws passes through each of the manufacturing equipment Em-B and the conveying equipment Ec-B that each correspond to the equipment Ea. The manufacturing equipment Em-B is one equipment after the conveying equipment Ec-A, and the conveying equipment Ec-B is two equipment after the conveying equipment Ec-A. The detailed information DI from the viewpoint V of the lead time transition as described above is useful for the operator O to compare the simulation result SR with the actual measured value.

Moreover, the information on lead time transition as the detailed information DI may also include the lead time of the workpiece Wb that passes through each piece of equipment E immediately before (e.g., one before) the selected workpiece Ws, as shown by a dashed triangle in FIG. 4. Similarly, the information on the lead time transition may also include the lead time of the workpiece Wa that passes through each piece of equipment E immediately after (e.g., one after) the selected workpiece Ws, as shown by a dashed square in FIG. 4.

Next, FIG. 5 is a diagram showing another example of the detailed information DI displayed on the display device 120. FIG. 5 shows a specific example of the detailed information DI from the viewpoint V of the histogram of the lead time. In FIG. 5, a histogram of the lead times for the selected workpiece Ws and the plurality of workpieces Wb and Wa before and after the selected workpiece Ws is shown as detailed information DI for each of a plurality of (e.g., four) consecutive pieces of equipment E (i.e., processes). Furthermore, as illustrated in FIG. 5, the display device 120 may display at least one of the maximum value (Max), the minimum value (Min), and the mode (Mo) of the lead time in the histogram for each piece of equipment E. According to the detailed information DI using the lead time histogram as described above, the operator O can easily check the deviation (e.g., standard deviation) of the lead time in each process (i.e., each piece of equipment E) and determine whether or not there is an abnormal value of the lead time.

Next, the detailed information DI from the viewpoint V of the position information is, for example, information on the position of a worker on a planar map of a factory having the production line 1. The position information includes at least information about the position at a time when the equipment E1 is used to produce the selected workpiece Ws. For example, the movement route of the worker may be displayed on the display device 120 as the position information. The position information as described above makes it possible to determine, for example, the position where the worker has come into contact with an automated conveyance machine. If the worker comes into contact with the automated conveyance machine, the automated conveyance machine will stop. Therefore, by using the position information, the operator O can identify the cause of the long lead time (i.e., the cause of the anomaly that has occurred) and consider changing the work schedule to reduce the contact.

Next, the detailed information DI from the viewpoint V of the equipment status is information indicating the operation status of the equipment E and includes at least information indicating the operation status of the equipment E1 for producing the selected workpiece Ws. More specifically, the information on the equipment status is displayed on the display device 120, for example, in the form of a graph showing in chronological order the operation status of the equipment E1 (e.g., operating rate, availability rate, ON/OFF of the equipment E1, operating status of each part of the equipment E1) over a designated period of time T. The designated period of time T mentioned here includes a time point t0 when the selected workpiece Ws passes through the equipment E1. The designated period of time T is, for example, a designated period of time before and after the time point t0. Alternatively, the designated period of time T may be at or before the time point to with the time point to being the end point or may be at or after the time point to with the time point to being the start point.

Moreover, the detailed information DI from the viewpoint V of the equipment status may include information indicating at least one of the operation status of the equipment E1 for the production of the workpiece Wb with the equipment E1 immediately before the selected workpiece Ws, and the operation status of the equipment E1 for the production of the workpiece Wa with the equipment E1 immediately after the selected workpiece Ws. Furthermore, the information on the equipment status may include information indicating at least one of the operation status of the equipment Eb for one or more processes immediately before the process using the equipment E1, and the operation status of the equipment Ea for one or more processes immediately after the process using the equipment E1.

According to the detailed information DI from the viewpoint V of the equipment status described above, the operator O can, for example, estimate which equipment E has stopped, estimate which part of a piece of equipment E has stopped, or estimate that the remaining amount of a material tank has run out.

Next, the detailed information DI from the viewpoint V of the worker status is information indicating the work performance of a worker and includes at least information indicating the performance of the work performed using the equipment E1 for the production of the selected workpiece Ws. More specifically, the information on the worker status is displayed on the display device 120, for example, in the form of a graph showing in chronological order the actual performance of the work (e.g., information indicating what work the worker has performed) performed using the equipment E1 over a specified period of time T. Moreover, the information on the worker status may include information indicating at least one of the performance of the work using the equipment E1 for the production of the workpiece Wb with the equipment E1 immediately before the selected workpiece Ws, and the performance of the work using the equipment E1 for the production of the workpiece Wa with the equipment E1 immediately after the selected workpiece Ws. Furthermore, the information on the worker status may include information indicating at least one of the actual performance of the work performed using the equipment Eb in one or more processes immediately before the process using the equipment E1, and the actual performance of the work performed using the equipment Ea in one or more processes immediately after the process using the equipment E1. According to the information on the worker status described above, the operator O can determine, for example, whether or not a designated process has stopped due to the worker performing another task.

Next, the detailed information DI from the viewpoint V of the inventory transition is information indicating the transition of the inventory quantity of workpiece W in the equipment E (including at least the equipment E1). More specifically, the information on the inventory transition is displayed on the display device 120, for example, in the form of a graph showing the inventory quantity in chronological order. Moreover, the information on the inventory transition may include information indicating at least one of the transition in the inventory quantity of the workpiece Wb in one or more processes immediately before the process using the equipment E1, and the transition in the inventory quantity of the workpiece Wa in one or more processes immediately after the process using the equipment E1. According to the information on the inventory transition described above, the operator O can determine, for example, whether or not the production has stopped due to the depletion of inventory.

Next, the detailed information DI from the viewpoint V of the order transition is information indicating the transition of ordered items and the quantities thereof to another factory (e.g., raw material factory, parts factory), and includes at least information indicating the transition of ordered items and the quantities thereof related to the equipment E1 for the production of the selected workpiece Ws. More specifically, the information on the order transition is displayed on the display device 120, for example, in the form of a graph showing the quantity of each ordered item in chronological order. Moreover, the information on the order transition may include information indicating at least one of the transition of ordered items and the quantities thereof related to the equipment Eb of one or more processes immediately before the process using the equipment E1, and the transition of ordered items and the quantities thereof related to the equipment Ea of one or more processes immediately after the process using the equipment E1. According to the information on the order transition described above, the operator O can determine, for example, whether or not the production has stopped due to a shortage of materials resulting from orders not being placed normally.

Next, the detailed information DI from the viewpoint V of the kanban transition is used in an example in which the production line 1 uses the kanban method. According to the kanban method, a tag called a “kanban” is sent from the previous process to the subsequent process together with a designated number of workpieces W produced in the previous process, and the kanban is returned to the previous process when the designated number of workpieces W sent are used in the subsequent process. Then, in the previous process, a designated number of workpieces W are produced again. For example, the information on the kanban transition is information indicating the transition of the number of kanbans returned from the subsequent process. Further, the information on the kanban transition may include, for example, information indicating the type of the kanban returned from the subsequent process. Examples of type of the kanban include a production instruction kanban for indicating the production amount and production time of the workpiece W and a withdrawal kanban for indicating the withdrawal amount of the workpiece W. When the process using the equipment E1 for the production of the selected workpiece Ws corresponds to the previous process described above, the information on the kanban transition is used as the detailed information DI. According to the information on the kanban transition described above, the operator O can determine, for example, whether or not the reason why the production has not started properly in the previous process is that the kanban has not been returned correctly to the previous process even though a designated number of workpieces W have been taken over to the subsequent process together with the kanban.

### 1-3. Effect

As described above, according to the analysis system 100 of the first embodiment, the detailed information DI regarding the equipment E1 at a time when the selected workpiece Ws passes through the equipment E1 is displayed. This makes it easier to identify the cause of an anomaly that occurs in relation to the selected workpiece Ws (e.g., the cause of a long lead time).

Moreover, as described above, the detailed information DI may include detailed information regarding the equipment E1 for at least one of the workpiece Wb passing through the equipment E1 immediately before the selected workpiece Ws, and the workpiece Wa passing through the equipment E1 immediately after the selected workpiece Ws. This makes it easier to efficiently identify which of the workpieces W supplied to the equipment E1 is causing the anomaly.

Furthermore, as described above, the detailed information DI may include detailed information regarding at least one of the equipment Eb through which the selected workpiece Ws passes immediately before the equipment E1, and the equipment Ea through which the selected workpiece Ws passes immediately after the equipment E1. This makes it easier to efficiently identify which of the equipment E1, the equipment Eb before the equipment E1, and the equipment Ea after the equipment E1 is causing the anomaly. In addition, if the equipment Eb used in the previous process is stopped, the equipment E1 that follows will also be stopped. For this reason, the use of the detailed information DI including the detailed information regarding the equipment Eb before the equipment E1 is particularly effective in identifying the cause of the anomaly.

### 1-4. Modification

As described above, the viewpoints V of the detailed information DI are various. Therefore, in this modified example, the analysis system 100 is configured to enable the operator O to select desired detailed information DI from among the detailed information DI from a plurality of viewpoints V.

FIG. 6 is a flowchart showing an example of the flow of processing executed by the analysis system 100 according to the modified example of the first embodiment. The processing of this flowchart is different from the flowchart shown in FIG. 2 in the following points.

In FIG. 6, when the operator input IN1 is detected (step S102; Yes), the processing proceeds to step S200. In step S200, the information processing device 110 displays, on the display device 120, a window WN2 (second window) for the operator O to select one of a plurality of viewpoints V. The processing then proceeds to step S202.

After the window WN2 is displayed by the processing of step S200, the information processing device 110 receives an operator input IN2 (second operator input) through the user interface 130 in step S202. The operator input IN2 is an input from the operator O who selects one of the plurality of viewpoints V displayed in the window WN2.

FIG. 7 is a diagram showing an example of a screen of the display device 120 including a display of the window WN2 together with the window WN1. In the example shown in FIG. 7, the window WN2 has a display of a button of “Details”. When the operator O selects a desired viewpoint V, the operator O operates the user interface 130 and presses the button of “Details”. As a result, as shown in FIG. 7, the colors of the text and background of the button of “Details” are inverted, and buttons showing each of the plurality of viewpoints V are displayed. The operator O selects one of the plurality of viewpoints V thus displayed (operator input IN2). In addition, in the following description, the viewpoint V selected by the operator O will be referred to as a “selected viewpoint Vs”.

In step S202, the information processing device 110 determines whether or not the operator input IN2 has been received. As a result, when the operator input IN2 is detected (step S202; Yes), the processing proceeds to step S204. In addition, for example, when there is no operator input IN2 within a designated period of time after the window WN2 is displayed, the information processing device 110 may end the processing shown in FIG. 6.

In step S204, in response to the operator input IN2, the information processing device 110 displays the detailed information DI from the selected viewpoint Vs on the display device 120 (see, for example, FIG. 4 or FIG. 5). In addition, after the detailed information DI from the selected viewpoint Vs is displayed by the processing of step S204, the information processing device 110 may receive further operator input IN2 until the analysis of the simulation result SR by the operator O using the analysis system 100 is completed. That is, steps S202 and S204 may be repeatedly executed until the analysis is completed.

As described above, the analysis system 100 according to the modified example is configured to be able to switch the detailed information DI between various viewpoints V. This makes it easier for the operator O to guess the cause of the anomaly.

### 2. Second Embodiment

### 2-1. Use of Expert Operation Log to Select Workpiece

According to the first embodiment described above, the lead time distribution of a plurality of workpieces W is displayed in the window WN1 (see FIG. 3). However, when the number of workpieces W displayed in the window WN1 increases, the operator O has more options to choose from, making it difficult for the operator O to decide which one to select. Furthermore, the maximum outlier in lead time does not necessarily directly lead to the cause of the anomaly. For example, when simply replacing a part, the lead time may be fairly long.

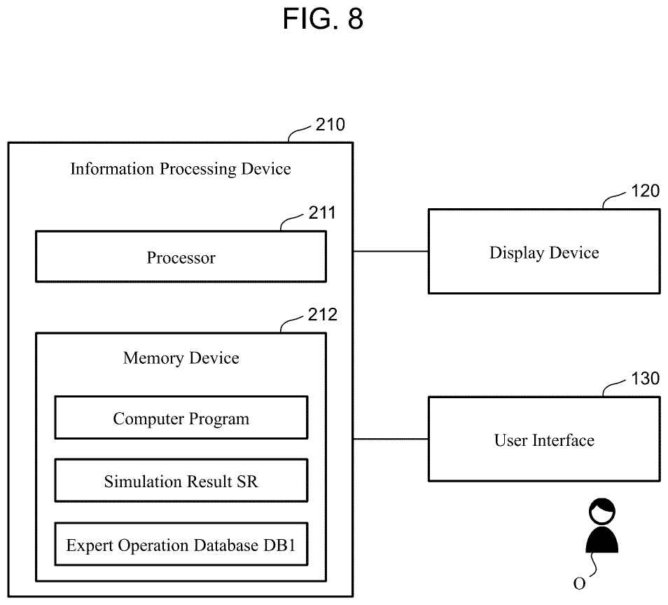

Therefore, in a production line analysis system 200 (see FIG. 8) according to the second embodiment, the operation log of an expert is used as follows in order to determine which workpiece W to select.

To be specific, the analysis system 200 automatically identifies a “recommended workpiece Wp” that is recommended to be selected for the current lead time distribution, based on an “expert operation database DB1 (first expert operation database)”. Then, in the window WN1, the recommended workpiece Wp is displayed so as to be distinguishable from other workpieces W.

FIG. 8 is a block diagram showing an example of a configuration of the analysis system 200 according to the second embodiment. The analysis system 200 is different from the analysis system 100 shown in FIG. 1 in the following points.

An information processing device 210 of the analysis system 200 includes a processor 211 and a memory device 212. The various kinds of information stored in the memory device 212 includes the expert operation database DB1 that accumulates operation logs of one or more experts for the window WN1. In other words, the expert operation database DB1 indicates the correspondence between a “lead time distribution for one or more pieces of equipment E” and a “selection result of workpiece W (selected workpiece Ws) by an expert”.

More specifically, the various kinds of processing executed by the processor 211 include obtaining an operation log of the user interface 130 during past analyses by one or more experts and storing the operation long in the memory device 212. As a result, the operation log of the expert for the window WN1 is accumulated in the memory device 212. In addition, whether the operator O is an expert or not can be determined based on, for example, operator identification (ID) information received from the operator O through the user interface 130 when the operator O accesses the analysis system 200.

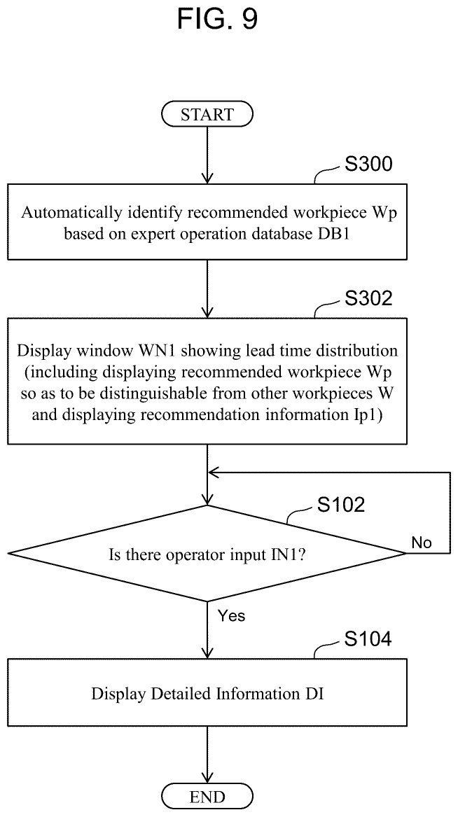

FIG. 9 is a flowchart showing an example of the flow of processing executed by the analysis system 200 according to the second embodiment to provide information to the operator O. The processing of this flowchart is different from the flowchart shown in FIG. 2 in the following points.

In step S300, the information processing device 210 automatically identifies a recommended workpiece Wp that is recommended to be selected for the current lead time distribution (more specifically, the lead time distribution based on the current simulation result SR) based on the expert operation database DB1.

In order to automatically identify the recommended workpiece Wp, the information processing device 110 may use, for example, the following machine learning model. That is, the information processing device 210 uses, as learning data, information from the expert operation database DB1, which accumulates the correspondence between the “lead time distribution for one or more pieces of equipment E” and the “selection result of workpiece W (selected workpiece Ws) by an expert”, to generate a machine learning model in advance. The machine learning model may be updated as appropriate using the latest information in the expert operation database DB1. Then, the information processing device 210 inputs the current lead time distribution into the machine learning model, thereby identifying the recommended workpiece Wp that is recommended to be selected for the current lead time distribution. The processing then proceeds to step S302.

In step S302, the information processing device 210 displays, on the display device 120, the window WN1 showing the lead time distribution, based on the current simulation result SR. At this time, the information processing device 210 displays the recommended workpiece Wp in the window WN1 so as to be distinguishable from other workpieces W.

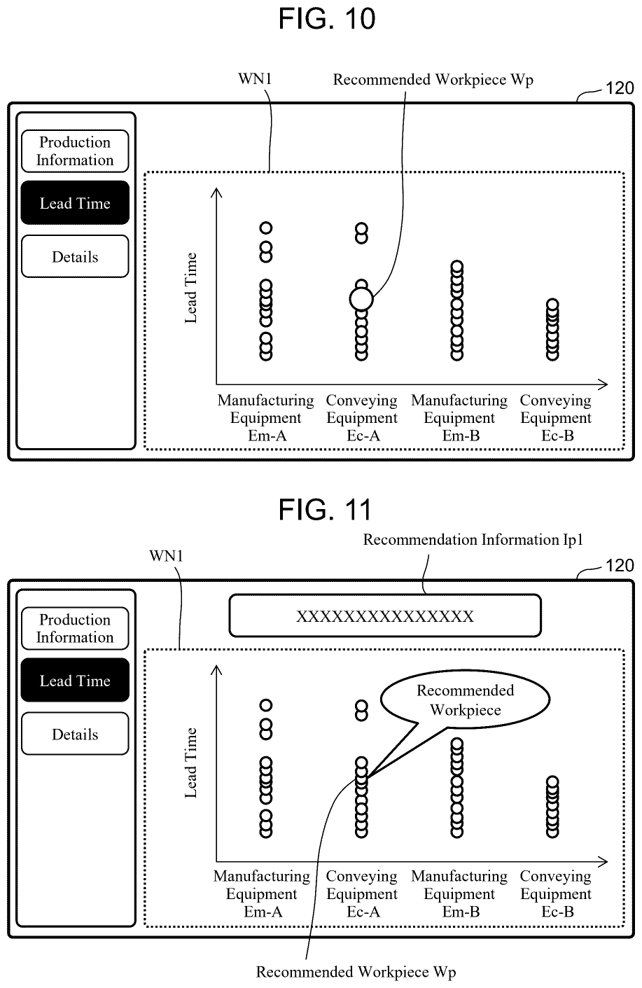

FIG. 10 is a diagram showing an example of a screen of the display device 120 including a display of the window WN1 accompanied by presentation of a recommended workpieces Wp. In one example of displaying the recommended workpiece Wp so as to be distinguishable from other workpieces W, the recommended workpiece Wp is displayed larger than the other workpieces W as shown in FIG. 10. In another example, the recommended workpiece Wp may be displayed in a color different from the color of the other workpieces W (more specifically, in a color (e.g., red) that attracts the attention of the operator O more than the color (e.g., black) of the other workpieces W). In yet another example, the recommended workpiece Wp may be displayed accompanied by a pop-up (see FIG. 11, for example) that is displayed in association with a circle indicating the recommended workpiece Wp.

Moreover, in step S302, the information processing device 210 may display, on the display device 120, recommendation information Ip1 (first recommendation information) that recommends the selection of the recommended workpiece Wp. The recommendation information Ip1 is, for example, a message recommending the selection of the recommended workpiece Wp. The message may be, for example, “the recommended workpiece has been identified based on the knowledge of a skilled operator of level xx or higher”. FIG. 11 is a diagram showing an example of a screen of the display device 120 including a display of the recommendation information Ip1. As illustrated in FIG. 11, the recommendation information Ip1 may be displayed in an area outside the window WN1. Alternatively, the recommendation information Ip1 may be displayed in the window WN1.

Additionally, the processing relating to the use of the expert operation log according to the second embodiment may be combined with the processing of a flowchart shown in FIG. 6. Specifically, after the processing of step S302 in FIG. 9, the processing of steps S200 to S204 (see FIG. 6) may be executed instead of the processing of steps S102 and S104.

### 2-2. Effect

As described above, according to the analysis system 200 of the second embodiment, the recommended workpiece Wp that is recommended to be selected in the window WN1 is presented based on the past operation log of the expert. This allows the operator O to efficiently select a workpiece W that is likely to lead to the identification of the cause of the anomaly. In addition, the analysis system 200 can adequately support the analysis of an unskilled operator O (unskilled person). In other words, the analysis system 200 can provide an analysis tool suitable as a training tool for an unskilled person.

### 3. Third Embodiment

### 3-1. Use of Expert Operation Log to Select Detailed Information

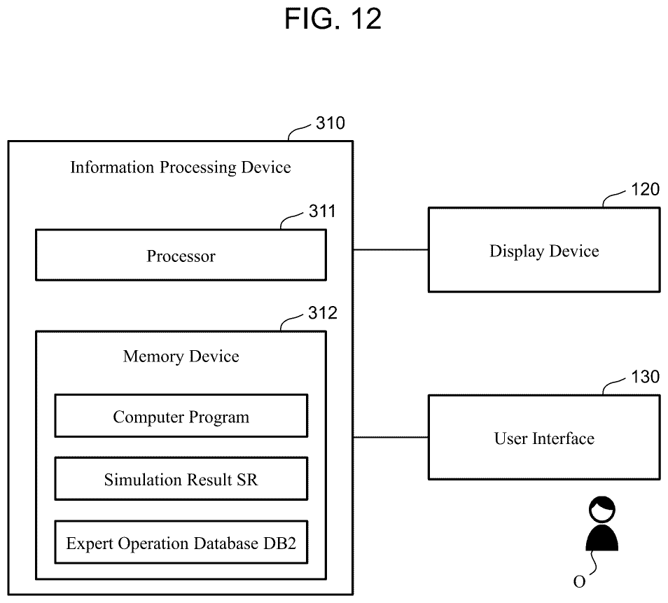

As described above, the viewpoints V of the detailed information DI are various. Therefore, in a production line analysis system 300 (see FIG. 12) according to the third embodiment, the operation log of the expert is used as follows to determine which detailed information DI from which viewpoint V is to be selected.

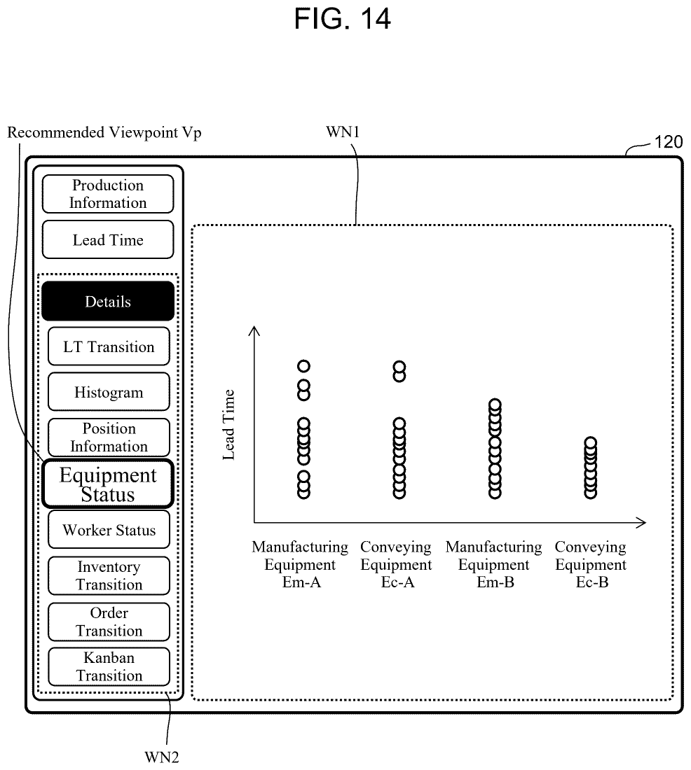

To be specific, the analysis system 300 automatically identifies a “recommended viewpoint Vp” that is recommended to be selected for the current lead time distribution, based on an “expert operation database DB2 (second expert operation database)”. Then, the recommended viewpoint Vp is displayed in the window WN2 (see, for example, FIG. 14) so as to be distinguishable from the other viewpoints V.

FIG. 12 is a block diagram showing an example of a configuration of the analysis system 300 according to the third embodiment. The analysis system 300 is different from the analysis system 100 shown in FIG. 1 in the following points.

An information processing device 310 of the analysis system 300 includes a processor 311 and a memory device 312. The various kinds of information stored in the memory device 312 includes the expert operation database DB2 that accumulates operation logs of one or more experts for the window WN2. In other words, like the expert operation database DB1 (see FIG. 8), the expert operation database DB2 indicates the correspondence between a “lead time distribution for one or more pieces of equipment E” and a “selection result of viewpoint V by an expert.”

More specifically, the various kinds of processing executed by the processor 311 include obtaining an operation log of the user interface 130 during past analyses by one or more experts and storing the operation log in the memory device 312. As a result, the operation log of the expert for the window WN2 is accumulated in the memory device 312.

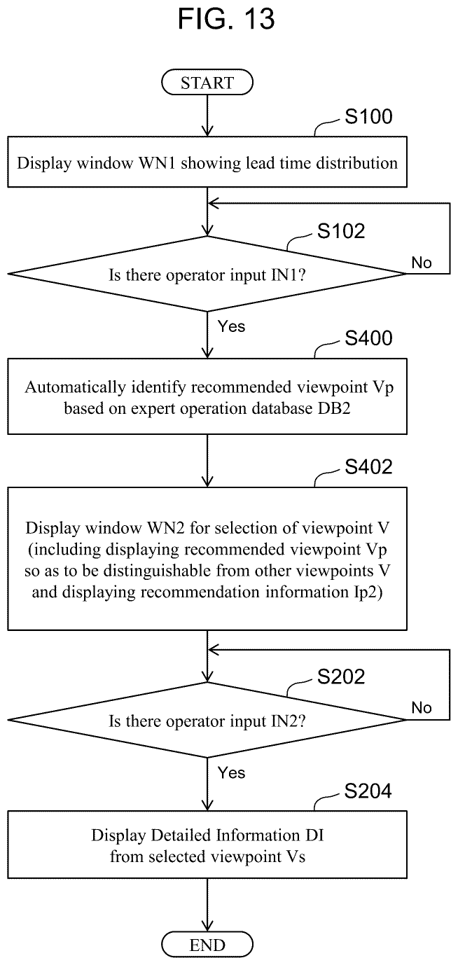

FIG. 13 is a flowchart showing an example of the flow of processing executed by the analysis system 300 according to the third embodiment to provide information to the operator O. The processing of this flowchart is different from the flowchart shown in FIG. 6 in the following points.

In FIG. 13, when the operator input IN1 is detected (step S102; Yes), the processing proceeds to step S400. In step S400, the information processing device 310 automatically identifies a recommended viewpoint Vp that is recommended to be selected for the current lead time distribution (more specifically, the lead time distribution based on the current simulation result SR) based on the expert operation database DB2.

In order to automatically identify the recommended viewpoint Vp, similarly to the recommended workpiece Wp, for example, a machine learning model generated using information in the expert operation database DB2 as learning data is used. Then, the information processing device 310 inputs the current lead time distribution into the machine learning model, thereby identifying a recommended viewpoint Vp that is recommended to be selected for the current lead time distribution. The processing then proceeds to step S402.

In step S402, the information processing device 310 displays, on the display device 120, the window WN2 for the operator O to select any one of a plurality of viewpoints V. At this time, the information processing device 310 displays the recommended viewpoint Vp in the window WN2 so as to be distinguishable from the other viewpoints V.

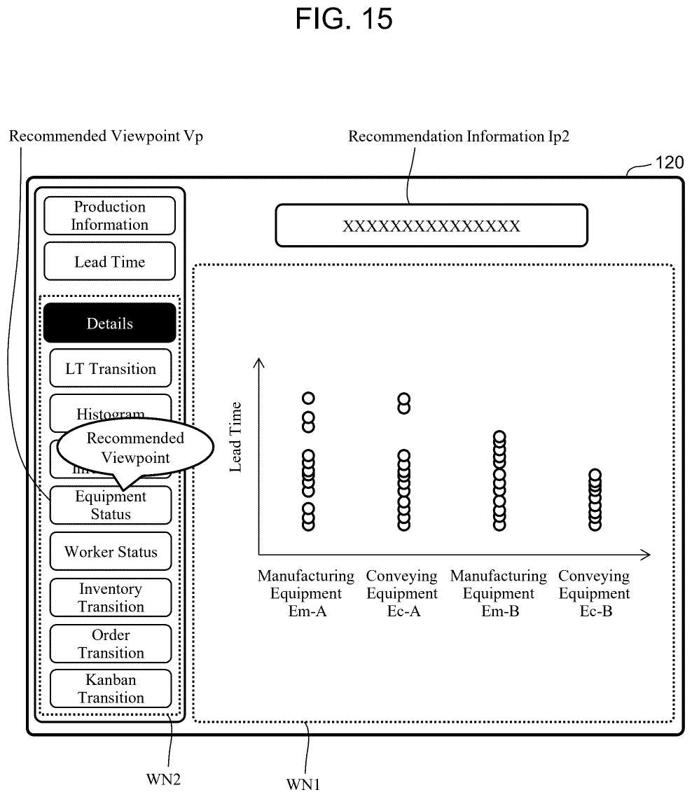

FIG. 14 is a diagram showing an example of a screen of the display device 120 including a display of the window WN2 accompanied by presentation of a recommended viewpoint Vp. In one example of displaying the recommended viewpoint Vp so as to be distinguishable from the other viewpoints V, the recommended viewpoint Vp is displayed larger than the other viewpoints V as shown in FIG. 14. In another example, the recommended viewpoint Vp may be displayed in a color different from the color of the other viewpoints V (more specifically, in a color (e.g., red) that attracts the attention of the operator O more than the color (e.g., black) of the other viewpoints V). In yet another example, the recommended viewpoint Vp may be displayed accompanied by a pop-up (see FIG. 15, for example) that is displayed in association with a button indicating the recommended viewpoint Vp.

Furthermore, in step S402, the information processing device 310 may display, on the display device 120, recommendation information Ip2 (second recommendation information) that recommends the selection of the recommended viewpoint Vp. The recommendation information Ip2 is, for example, a message recommending the selection of the recommended viewpoint Vp. The message is, for example, “the recommended viewpoint is most frequently selected by skilled operators of level xx or higher”. FIG. 15 is a diagram showing an example of a screen of the display device 120 including a display of the recommendation information Ip2. As illustrated in FIG. 15, the recommendation information Ip2 may be displayed in an area outside the window WN2. Alternatively, the recommendation information Ip2 may be displayed in the window WN2.

Additionally, the processing relating to the use of the expert operation log according to the third embodiment may be executed together with the processing relating to the use of the expert operation log according to the second embodiment. Specifically, the memory device 312 of the analysis system 300 may store the expert operation database DB1 together with the expert operation database DB2. Further, in FIG. 13, the processing of steps S300 and S302 (see FIG. 9) may be executed instead of the processing of step S100.

### 3-2. Effect

As described above, according to the analysis system 300 of the third embodiment, the recommended viewpoint Vp that is recommended to be selected in the window WN2 is presented based on the past operation log of the expert. This allows the operator O to efficiently select detailed information DI that is likely to lead to the identification of the cause of the anomaly. In addition, the analysis system 300 can also adequately support the analysis of an unskilled operator O (unskilled person). In other words, the analysis system 300 can also provide an analysis tool suitable as a training tool for an unskilled person.

What is claimed is:

1. A production line analysis system, comprising processing circuitry, a display device, and a user interface, wherein
the processing circuitry is configured to:
display, on the display device, a first window showing a lead time distribution of a plurality of workpieces that have passed through first equipment included in one or more pieces of equipment, based on a result of a simulation of a production line including the one or more pieces of equipment;
receive, through the user interface, a first operator input to select one of the plurality of workpieces displayed in the first window; and
in response to the first operator input, display, on the display device, detailed information regarding the first equipment at a time when a selected workpiece, which is a workpiece selected by the first operator input, passes through the first equipment.

2. The production line analysis system according to claim 1, further comprising a first expert operation database in which operation logs of one or more experts for the first window are accumulated, wherein
the processing circuitry is further configured to:
automatically identify a recommended workpiece that is recommended to be selected for a current lead time distribution, based on the first expert operation database; and
display the recommended workpiece in the first window so as to be distinguishable from one or more other workpieces.

3. The production line analysis system according to claim 2, wherein
the processing circuitry is further configured to display, on the display device, first recommendation information that recommends selection of the recommended workpiece.

4. The production line analysis system according to claim 1, wherein
the detailed information includes detailed information from a plurality of viewpoints, and
the processing circuitry is further configured to:
display, on the display device, a second window for selecting any one of the plurality of viewpoints;
receive, through the user interface, a second operator input to select one of the plurality of viewpoints displayed on the second window; and
display detailed information from the selected viewpoint on the display device in response to the second operator input.

5. The production line analysis system according to claim 4, further comprising a second expert operation database in which operation logs of one or more experts for the second window are accumulated, wherein
the processing circuitry is further configured to:
automatically identify a recommended viewpoint that is recommended to be selected for a current lead time distribution, based on the second expert operation database; and
display the recommended viewpoint in the second window so as to be distinguishable from one or more other viewpoints.

6. The production line analysis system according to claim 5, wherein
the processing circuitry is further configured to display, on the display device, second recommendation information that recommends selection of the recommended viewpoint.

7. The production line analysis system according to claim 1, wherein
the detailed information includes detailed information regarding the first equipment for at least one of a workpiece passing through the first equipment immediately before the selected workpiece and a workpiece passing through the first equipment immediately after the selected workpiece.

8. The production line analysis system according to claim 1, wherein
the detailed information includes detailed information regarding at least one of equipment through which the selected workpiece passes immediately before the first equipment and equipment through which the selected workpiece passes immediately after the first equipment.

9. A production line analysis method executed by a computer, comprising:
displaying, on a display device, a first window showing a lead time distribution of a plurality of workpieces that have passed through first equipment included in one or more pieces of equipment, based on a result of a simulation of a production line including the one or more pieces of equipment;
receiving, through a user interface, a first operator input to select one of the plurality of workpieces displayed in the first window; and
in response to the first operator input, displaying, on the display device, detailed information regarding the first equipment at a time when a selected workpiece, which is a workpiece selected by the first operator input, passes through the first equipment.

10. A non-transitory computer-readable recording medium storing a production line analysis program executed by a computer,
the production line analysis program causing the computer to execute:
displaying, on a display device, a first window showing a lead time distribution of a plurality of workpieces that have passed through first equipment included in one or more pieces of equipment, based on a result of a simulation of a production line including the one or more pieces of equipment;
receiving, through a user interface, a first operator input to select one of the plurality of workpieces displayed in the first window; and
in response to the first operator input, displaying, on the display device, detailed information regarding the first equipment at a time when a selected workpiece, which is a workpiece selected by the first operator input, passes through the first equipment.
